(19) United States
(12) Patent Application Publication
(10) Pub. No.: US 2026/0173235 A1
(43) Pub. Date: Jun. 18, 2026

(54) LAMP SYSTEM AND CONTROL METHOD THEREOF

(71) Applicant: HYUNDAI MOBIS CO., LTD., Seoul (KR)

(72) Inventor: Myeong Je KIM, Yongin-si (KR)

(73) Assignee: HYUNDAI MOBIS CO., LTD., Seoul (KR)

(21) Appl. No.: 19/338,671

(22) Filed: Sep. 24, 2025

(30) Foreign Application Priority Data
Dec. 18, 2024 (KR) 10-2024-0189635

(51) Int. Cl. H05B 47/105; G01K 7/34; H04R 1/02; H04R 3/00; H04R 17/00; H04R 29/00

(52) U.S. Cl. CPC H05B 47/105; G01K 7/34; H04R 1/028; H04R 3/00; H04R 17/00; H04R 29/001

(57) ABSTRACT

A lamp system including a light source unit including at least one light source, a sound output unit including a piezoelectric element, a monitoring unit including a sensor circuit to measure supply power information including at least one of current and voltage supplied to the piezoelectric element, and a control unit to control at least one of the light source unit and the sound output unit based on an output of the monitoring unit. The control unit estimates a temperature of the piezoelectric element based on the supply power information, and controls at least one of the light source unit and the sound output unit according to the estimated temperature.

### CROSS-REFERENCE TO RELATED APPLICATION

The present application claims priority to Korean Patent Application No. 10-2024-0189635, filed on Dec. 18, 2024, the entire contents of which is incorporated herein for all purposes by this reference.

### BACKGROUND

### Field of the Invention

The present invention relates to a lamp system and a control method thereof, and more particularly, to a sound-linked lamp system mounted in a vehicle and a control method thereof.

### Description of the Related Art

In a conventional lamp system, damage or degradation in performance may occur due to an increase in the temperature of the light-emitting diode (LED). To prevent such issues, techniques involving temperature monitoring using temperature sensors, such as negative temperature coefficient (NTC) thermistors, and controlling the current accordingly have been employed. However, these techniques require the addition of separate sensor components, which increases both the cost and complexity of the system.

Meanwhile, a piezoelectric element exhibits impedance characteristics that vary with temperature, and thus temperature can be estimated based on the impedance of the piezoelectric element. However, the temperature data obtained from the impedance of the piezoelectric element includes heat generated by the piezoelectric element itself, therefore, calibration is required to accurately determine the ambient temperature.

Accordingly, the present invention proposes a technique for monitoring temperature based on piezoelectric impedance, estimating accurate ambient temperature through temperature calibration, and controlling the light source unit and the sound output unit of the lamp system based on the estimated temperature.

### DOCUMENTS OF RELATED ART

(Patent Document 1) Korean Patent Publication No. 10-2021-0105611 (“Vehicle and Control Method Thereof,” Publication Date: Aug. 27, 2021)

### SUMMARY

The present invention has been devised to solve the above problems, and it is an object of the present invention to provide a lamp system and a control method thereof that are capable of sound output.

In order to accomplish the above object, a lamp system according to various embodiments of the present invention includes a sound output unit including a piezoelectric element, a monitoring unit including a sensor circuit configured to measure supply power information including at least one of current and voltage supplied to the piezoelectric element, and a control unit configured to control at least one of the light source unit and the sound output unit based on an output of the monitoring unit, wherein the control unit is configured to estimate a temperature of the piezoelectric element based on the supply power information, and to control at least one of the light source unit and the sound output unit according to the estimated temperature.

In addition, the control unit may be configured to calculate an impedance of the piezoelectric element based on the supply power information, estimate the temperature of the piezoelectric element based on the calculated impedance, and control at least one of the light source unit and the sound output unit according to the estimated temperature.

In addition, the control unit may be configured to estimate the temperature of the piezoelectric element based on the calculated impedance, to decrease an output voltage of the piezoelectric element in a case in which the estimated temperature is greater than or equal to a predetermined threshold, and to increase the output voltage of the piezoelectric element in a case in which the estimated temperature is less than the predetermined threshold.

In addition, the control unit may be configured to calculate an ambient temperature estimation value by correcting a self-heating value of the piezoelectric element from the estimated temperature of the piezoelectric element.

In addition, the control unit may be configured to decrease current supplied to the light source unit in a case in which the ambient temperature estimation value is greater than or equal to a predetermined threshold, and to maintain or to increase the current supplied to the light source unit in a case in which the ambient temperature estimation value is less than the predetermined threshold.

In addition, the control unit may be configured to perform a current derating function to gradually decrease the current supplied to the light source unit as the ambient temperature estimation value increases.

In addition, the control unit, in a temperature calibration mode, may be configured to estimate the temperature of the piezoelectric element for a predetermined time, compare the estimated temperature with a pre-stored basic characteristic graph, and store a calibration characteristic graph reflecting an offset between the estimated temperature estimated and the characteristic graph.

A control method of a lamp system including a light source unit, a sound output unit, a monitoring unit, and a control unit includes (a) acquiring, by the monitoring unit, supply power information including at least one of current and voltage supplied to a piezoelectric element included in the sound output unit, and (b) controlling, by the control unit based on an output of the monitoring unit, at least one of the light source unit and the sound output unit, wherein (b) includes calculating an impedance of the piezoelectric element based on the supply power information, estimating a temperature of the piezoelectric element based on the calculated impedance, and controlling at least one of the light source unit and the sound output unit according to the estimated temperature.

In addition, (b) may include estimating the temperature of the piezoelectric element based on the calculated impedance, reducing the output voltage of the piezoelectric element in a case in which the estimated temperature is equal to or greater than a predetermined threshold, and increasing the output voltage of the piezoelectric element in a case in which the estimated temperature is less than the predetermined threshold.

In addition, (b) may include calculating an ambient temperature estimation value by correcting a self-heating value of the piezoelectric element from the estimated temperature of the piezoelectric element, reducing current supplied to the light source unit in a case in which the ambient temperature estimation value is equal to or greater than a predetermined threshold, and maintaining or increasing current supplied to the light source unit in a case in which the ambient temperature estimation value is less than the predetermined threshold.

### BRIEF DESCRIPTION OF THE DRAWINGS

FIG. 1 is a schematic diagram illustrating a lamp system according to the present invention;

FIG. 2 is a circuit diagram illustrating a monitoring unit according to the present invention;

FIG. 3 is a temperature-sound output graph according to the present invention;

FIG. 4 is a time-temperature graph of ambient temperature and ambient temperature plus heat generated by the piezoelectric element according to the present invention;

FIG. 5 is a time-temperature graph of default characteristics and calibration characteristics according to the present invention; and

FIG. 6 is a flowchart illustrating a control method of the lamp system according to the present invention.

### DETAILED DESCRIPTION

To explain the present invention, its operational advantages, and the objectives achieved through its implementation, preferred embodiments of the present invention are illustrated and described below with reference thereto.

First, the terms used in this application are merely intended to describe specific embodiments and are not intended to limit the scope of the present invention, and singular expressions may include plural expressions unless the context clearly indicates otherwise. Additionally, in this application, terms such as “comprising” or “having” are intended to indicate the presence of the features, numbers, steps, operations, components, parts, or combinations thereof described in the specification, but do not preclude the presence or addition of one or more other features, numbers, steps, operations, components, parts, or combinations thereof.

In describing the present invention, detailed descriptions of well-known configurations or functions may be omitted so as not to obscure the subject matter of the invention.

The lamp system 1000 according to the present invention includes a process of calculating the impedance of a piezoelectric element 220 by monitoring the current and voltage of the piezoelectric element 220, and estimating the temperature of the piezoelectric element 220 and the ambient temperature based on the calculated impedance. In particular, during the temperature estimation process, the heat generated by the piezoelectric element itself is calibrated, allowing accurate estimation of the ambient temperature and thereby ensuring stable operation of the lamp system 1000.

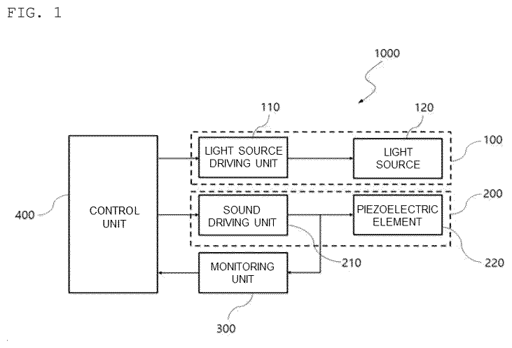

FIG. 1 is a schematic diagram illustrating a lamp system according to the present invention.

As shown in FIG. 1, the lamp system 1000 according to the present invention may include a light source unit 100, a sound output unit 200, a monitoring unit 300, and a control unit 400.

The light source unit 100 may include at least one light-emitting element (light source 120) such as an LED and a lens to provide illumination. Since the LED may be damaged at high temperatures, the current may be adjusted by the control unit 400 to manage the temperature of the light source unit 100.

The sound output unit 200 may include a piezoelectric element 220 and output sound through vibration.

The monitoring unit 300 may measure the current and voltage supplied to the piezoelectric element 220, and specifically may use an internal sensor circuit to acquire power supply information including at least one of the current and voltage.

The controller 400 may receive power supply information from the monitoring unit 300, estimate the temperature of the piezoelectric element 220 based on the received information, and control the operation of at least one of the light source unit 100 and the sound output unit 200 according to the estimated temperature.

Specifically, the control unit 400 may receive the power supply information supplied to the piezoelectric element 220 from the monitoring unit 300 and calculate the impedance of the piezoelectric element 220 based on the received information. In addition, the control unit 400 may estimate the temperature of the piezoelectric element 220 based on the calculated impedance and control the operation of the light source unit 100 and the piezoelectric element 220 according to the estimated temperature.

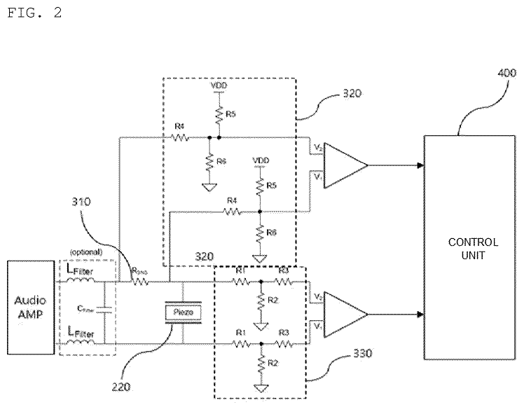

FIG. 2 is a circuit diagram illustrating a monitoring unit according to the present invention.

As shown in FIG. 2, the monitoring unit 300 may include a resistor 310, a DC circuit 320, and a voltage divider circuit 330 to monitor the current and voltage supplied to the piezoelectric element 220.

The resistor 310 may be provided in series at one end of the piezoelectric element 220.

The DC circuit 320 may measure the current by detecting the voltage difference across the resistor 310 and knowing the resistance value of the resistor 310.

The voltage divider circuit 330 may measure the voltage applied to the piezoelectric element 220 by using the voltage difference across both ends of the piezoelectric element 220.

Accordingly, the control unit 400 may calculate the impedance based on an impedance calculation formula using the measured current and voltage.

$$impedance ( resistance ) = \frac{voltage}{current} \qquad Equation 1$$

Thereafter, the control unit 400 may control the output of the sound output unit 200 according to temperature based on the impedance calculated from the monitoring unit 300.

The capacitance and impedance characteristics of the piezoelectric element 220 are affected by temperature. Capacitance increases as temperature rises and decreases as temperature falls. In addition, impedance decreases as temperature rises and increases as temperature falls. In summary, as temperature rises, capacitance increases and impedance characteristics decrease, which can improve output. Also, as temperature falls, capacitance decreases and impedance characteristics increase, which can decrease output.

Based on these facts, the control unit 400 may estimate temperature based on the calculated impedance and adjust the output voltage of the piezoelectric element 220 according to the temperature.

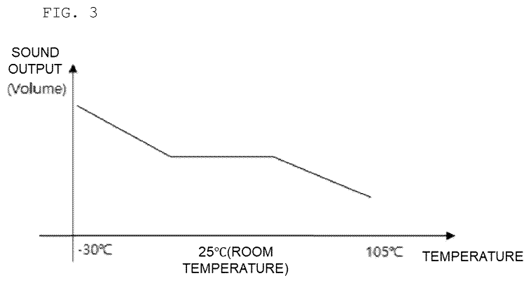

FIG. 3 is a temperature-sound output graph according to the present invention.

As shown in FIG. 3, when the control unit 400 determines that the calculated impedance is below a predetermined threshold, it concludes that the temperature of the piezoelectric element 220 is above the predetermined threshold and may decrease the output voltage supplied to the piezoelectric element 220. Also, when the control unit 400 determines that the calculated impedance is above the predetermined threshold, it concludes that the temperature of the piezoelectric element 220 is below the predetermined threshold and may increase the output voltage of the piezoelectric element 220. Thus, the piezoelectric element 220 can be controlled to output a constant sound pressure regardless of temperature.

Meanwhile, to protect the light source 120 from damage caused by high temperatures, derating control is applied in headlamps to decrease current when temperatures are high. For temperature monitoring, components such as NTC thermistors are used, which estimate temperature by measuring resistance values that vary with temperature.

FIG. 4 is a time-temperature graph of ambient temperature and ambient temperature plus heat generated by the piezoelectric element according to the present invention.

In the present invention, temperature monitoring based on the impedance of the piezoelectric element 220 is also possible. However, as shown in FIG. 4, the temperature value estimated from the impedance of the piezoelectric element 220 may include self-heating generated when the piezoelectric element 220 vibrates. Therefore, the control unit 400 may exclude the self-heating value of the piezoelectric element 220 to obtain an ambient temperature estimation. Here, the self-heating characteristics of the piezoelectric element can be obtained through test data.

Accordingly, when the calculated ambient temperature is equal to or greater than a predetermined threshold, the control unit 400 may decrease the current applied to the light source unit 100, and when the calculated ambient temperature is below the predetermined threshold, it may maintain or increase the current to the light source 120. Additionally, the control unit 400 may perform a current derating function by gradually reducing the current to the light source unit 100 as the estimated ambient temperature increases, thereby preventing damage caused by temperature rise in the light source unit 100.

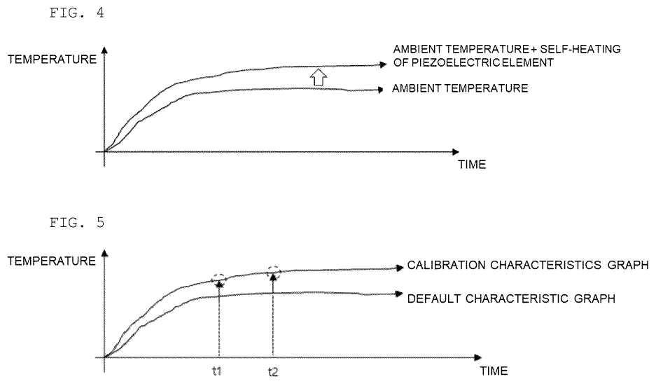

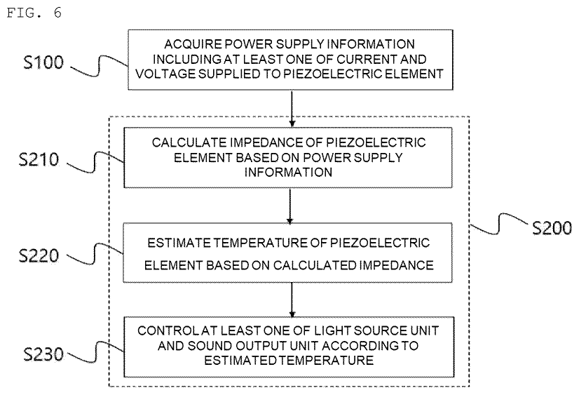

FIG. 5 is a time-temperature graph of default characteristics and calibration characteristics according to the present invention.

As shown in FIG. 5, the control unit 400 may process impedance data to calibrate the temperature characteristics of the piezoelectric element 220. This may include measuring the impedance of the piezoelectric element 220 over a predetermined time during an initial aging test and correcting the deviation (offset) between the temperature estimated based on the measured impedance and a reference characteristic graph. The calibrated characteristic data may be stored in the control unit 400 as a calibration characteristic graph and used to improve the accuracy of temperature estimation. In addition, the control unit 400 may utilize the self-heating data of the piezoelectric element 220 to eliminate errors occurring during impedance-based temperature estimation and calculate an accurate ambient temperature.

Furthermore, unlike conventional methods using separate temperature sensors such as NTC thermistors, the lamp system 1000 according to the present invention provides an efficient and simple design by utilizing the intrinsic characteristics of the piezoelectric element 220. The technology for monitoring temperature through the impedance of the piezoelectric element 220 enables stable driving of the light source 120 without adding separate sensors, thereby reducing system complexity and enhancing reliability. Moreover, by correcting for the self-heating of the piezoelectric element 220, it is possible to improve the accuracy of temperature measurement, accurately reflect the ambient temperature, and ensure the optimal operation of the light source unit 100 and the sound output unit 200.

Through the temperature estimation and calibration process, the present invention can maintain the performance of the lamp system 1000 under various environmental conditions. The light source unit 100 and the piezoelectric element 220 quickly respond to environmental changes through real-time data processing, thereby extending the overall lifespan of the lamp and enhancing the user experience. In particular, by preventing high-temperature damage to the light source 120 and providing stable lighting and sound output, the present invention is suitable for implementing a high-performance lamp system.

FIG. 6 is a flowchart illustrating a control method of the lamp system according to the present invention.

As shown in FIG. 6, a control method of a lamp system including a light source unit, a sound output unit, a monitoring unit, and a control unit according to the present invention may include, in operation S100, acquiring, by the monitoring unit, power supply information including at least one of a current and a voltage supplied to a piezoelectric element included in the sound output unit, and in operation S200, controlling, by the control unit, at least one of the light source unit and the sound output unit based on the output of the monitoring unit.

In this case, the control unit may calculate the impedance of the piezoelectric element based on the power supply information in operation S210, estimate the temperature of the piezoelectric element based on the calculated impedance in operation S220, and control at least one of the light source unit and the sound output unit according to the estimated temperature in operation S230.

Specifically, in operation S230, when the estimated temperature of the piezoelectric element is equal to or greater than a predetermined threshold, the control unit may decrease the output voltage of the piezoelectric element, and when the estimated temperature of the piezoelectric element is less than the predetermined threshold, it may increase the output voltage of the piezoelectric element.

In addition, the control unit may correct for the self-heating of the piezoelectric element from the temperature estimated in operation S220 to calculate an estimated ambient temperature. Then, in operation S230, when the estimated ambient temperature is equal to or greater than a predetermined threshold, the control unit may decrease the current applied to the light source unit, and when the estimated ambient temperature is below the predetermined threshold, it may maintain or increase the current applied to the light source unit.

A lamp system and control method thereof according to various embodiments of the present invention are advantageous for outputting sound within the sealed structure of the lamp without using a speaker.

Also, since temperature is monitored using the impedance of the piezoelectric element, there is no need to add a separate temperature sensor, thereby reducing system cost and complexity.

In addition, accurate ambient temperature can be estimated by calibrating the heat generated by the piezoelectric element itself.

Furthermore, the performance of the light source unit and the sound output unit can be stably maintained despite temperature variations.

Also, by calibrating temperature characteristics through initial aging tests, consistent performance of the lamp system can be ensured.

Moreover, damage to the light source caused by high temperatures can be prevented, thereby extending the lifespan of the lamp system.

While preferred embodiments of the present invention have been described above, the embodiments disclosed herein are intended to be illustrative and not limiting of the scope of the invention. Accordingly, the technical scope of the invention is not limited to the disclosed embodiments but encompasses combinations of the disclosed embodiments, and the scope of the invention is not limited by these embodiments. Furthermore, it will be apparent to those skilled in the art that various changes and modifications can be made to the present invention without departing from the spirit or scope of the attached claims, and all such variations and modifications are intended to fall within the scope of the present invention.

### DESCRIPTION OF REFERENCE NUMERALS

1000: lamp system
100: light source unit
110: light source driving unit
120: light source
200: sound output unit
210: sound driving unit
220: piezoelectric element
300: monitoring unit
310: resistor
320: DC circuit
330: voltage divider circuit
400: control unit

What is claimed is:

1. A lamp system comprising:
a light source unit including at least one light source;
a sound output unit including a piezoelectric element;
a monitoring unit including a sensor circuit configured to measure supply power information including at least one of current and voltage supplied to the piezoelectric element; and
a control unit configured to control at least one of the light source unit and the sound output unit based on an output of the monitoring unit,
wherein the control unit is configured to estimate a temperature of the piezoelectric element based on the supply power information, and to control at least one of the light source unit and the sound output unit according to the estimated temperature.

2. The lamp system of claim 1, wherein the control unit is configured to calculate an impedance of the piezoelectric element based on the supply power information, to estimate the temperature of the piezoelectric element based on the calculated impedance, and to control at least one of the light source unit and the sound output unit according to the estimated temperature.

3. The lamp system of claim 2, wherein the control unit is configured to estimate the temperature of the piezoelectric element based on the calculated impedance, to decrease an output voltage of the piezoelectric element in a case in which the estimated temperature is greater than or equal to a predetermined threshold, and to increase the output voltage of the piezoelectric element in a case in which the estimated temperature is less than the predetermined threshold.

4. The lamp system of claim 1, wherein the control unit is configured to calculate an ambient temperature estimation value by correcting a self-heating value of the piezoelectric element from the estimated temperature of the piezoelectric element.

5. The lamp system of claim 4, wherein the control unit is configured to decrease current supplied to the light source unit in a case in which the ambient temperature estimation value is greater than or equal to a predetermined threshold, and to maintain or to increase the current supplied to the light source unit in a case in which the ambient temperature estimation value is less than the predetermined threshold.

6. The lamp system of claim 5, wherein the control unit is configured to perform a current derating function to gradually decrease the current supplied to the light source unit as the ambient temperature estimation value increases.

7. The lamp system of claim 1, wherein the control unit, in a temperature calibration mode, is configured to estimate the temperature of the piezoelectric element for a predetermined time, to compare the estimated temperature with a pre-stored basic characteristic graph, and to store a calibration characteristic graph reflecting an offset between the estimated temperature estimated and the characteristic graph.

8. A control method of a lamp system including a light source unit, a sound output unit, a monitoring unit, and a control unit, the method comprising:
(a) acquiring, by the monitoring unit, supply power information including at least one of current and voltage supplied to a piezoelectric element included in the sound output unit; and
(b) controlling, by the control unit based on an output of the monitoring unit, at least one of the light source unit and the sound output unit,
wherein (b) comprises calculating an impedance of the piezoelectric element based on the supply power information, estimating a temperature of the piezoelectric element based on the calculated impedance, and controlling at least one of the light source unit and the sound output unit according to the estimated temperature.

9. The control method of claim 8, wherein (b) comprises:
estimating the temperature of the piezoelectric element based on the calculated impedance;
reducing the output voltage of the piezoelectric element in a case in which the estimated temperature is equal to or greater than a predetermined threshold; and
increasing the output voltage of the piezoelectric element in a case in which the estimated temperature is less than the predetermined threshold.

10. The control method of claim 8, wherein (b) comprises:
calculating an ambient temperature estimation value by correcting a self-heating value of the piezoelectric element from the estimated temperature of the piezoelectric element;
reducing current supplied to the light source unit in a case in which the ambient temperature estimation value is equal to or greater than a predetermined threshold; and
maintaining or increasing current supplied to the light source unit in a case in which the ambient temperature estimation value is less than the predetermined threshold.
